(19) United States
(12) Patent Application Publication
(10) Pub. No.: US 2019/0208289 A1
(43) Pub. Date: Jul. 4, 2019

(54) SYSTEM AND METHOD FOR ENHANCING HUMAN MEMORY RECOLLECTION AND CATALOGING THROUGH AN AUTOGENERATED VIDEO JOURNAL

(71) Applicant: VID INC., Los Angeles, CA (US)

(72) Inventors: Jagpal Singh, Worcester (GB); Maciej Dziedziela, Calabasas, CA (US)

(73) Assignee: VID INC., Los Angeles, CA (US)

(21) Appl. No.: 16/201,597

(22) Filed: Nov. 27, 2018

Related U.S. Application Data
(63) Continuation-in-part of application No. 15/686,842, filed on Aug. 25, 2017, now Pat. No. 10,178,365.

(51) Int. Cl. H04N 21/8547; G06Q 50/00; H04N 21/835; H04L 9/32

(52) U.S. Cl. CPC H04N 21/8547; H04L 9/3221; H04N 21/835; G06Q 50/01

(57) ABSTRACT

A method for assisting at least one author to generate and view video(s). The method comprises allowing a user to create a video project for generating a video; recording a plurality of video clips; organizing the video clips; stitching the video clips together to create a composite video; and displaying a representation of the composite video in a calendar-type display. The method further including publishing the composite video via a video server to a plurality of users connected to the video server.

### RELATED APPLICATIONS

This application is a continuation in part of U.S. application Ser. No. 15/686,842, titled “System and Method for Combining Audio Tracks with Video Files,” filed on Aug. 25, 2017, the entirety of which is incorporated herein in their entirety by reference.

### BACKGROUND

High definition cameras have become a common feature in all sorts of consumer electronic devices, ranging form computers to laptops, tablets, PDAs, and smart phones. Consumers can easily record videos in high quality and share them with friends across different social-media platforms, such as YouTube, Facebook, Snapchat and Instagram. Smartphone devices typically have a limited memory capacity (e.g., 32 Gb). But these devices are capable of capturing video in 4 k at up to 60 fps. Such high definition videos have a very large file size. For example, a one minute long video in this format can have a size of approximately 400 Mb. When taking into account memory storage used for a smartphone device's operating system, music, and applications, the amount of memory left to store such videos is very limited. As a result of this lack of storage space, combined with other factors, it is typical for smartphone users to capture only select moments of their life. These factors may include lack of easy organization and cataloging of memories on a default smartphone library, the time and skill necessary to edit raw footage suitable for sharing on social media, and the general effort required to constantly capture footage.

### SUMMARY

An objective of the present application is to provide a video creation system and method through which users can meaningfully enhance their ability to remember, store, and catalog their lives and memories. Videos created, stored, and cataloged according to aspects of the present application may be published in the accounts of users on a social media platform such that followers of users can have a direct access to the videos as a news or media feed pushed by the current system and method to an account or device of the followers. For example, the system and method as set forth in the present application may be implemented as a server-mobile App system, such as “Vid Platform,” and the users of the server-mobile App system form their own social platform and share memories among themselves.

To achieve the above-identified objectives, the present system and method enables user captured videos to be instantly uploaded to a cloud server, which requires no local storage on the user's mobile device. For example, the present system and method may automatically transmit a locally created video from the user's mobile device to cloud storage associated with the Vid Platform.

Another benefit of the system and method of the present application is through the use of a calendar-type organization and presentation of videos. To achieve such a benefit, the present system and method may create a calendar-type user interface. Through tagging of the videos, a user is able to quickly search for and retrieve videos, promoting recollection of user memories and events.

According to an aspect, the present application is directed to a method for combining audio tracks with the user created videos. The methods for combining audio and video is described in U.S. application Ser. No. 15/686,842, titled “System and Method for Combining Audio Tracks with Video Files”, which is hereby incorporated in its entirety.

Another objective of the present application is to provide a video creation system and method such that videos created by a user (or a plurality of users) may be stored, organized, and presented according to date and/or time information. For example, each user may create a plurality of videos, as well as group videos with other users. The created videos may each have metadata associated therewith, the metadata including date and time information. According to embodiments, the date and time information corresponds to the date and time the video was created, the length of the video, the date and time the video finished recording, and/or the number of days and associated dates that the video spans.

According to further embodiments, a plurality of created videos may be linked. For example, a plurality of videos (or clips) created over a plurality of days by a single user may be linked. The link may be created according to the metadata. According to alternative embodiments, a plurality of videos may be linked according to user input. According to still further embodiments, a plurality of videos may be linked according to the subject matter of the videos. For example, the meta data associated with each created video may further include location information. The location information may correspond to a location where the created video was made.

The videos may be published in the accounts of participants on a social media platform such that followers of these participants can have a direct access to the same videos or may be published as a news or media feed pushed by the current system and method to an account or device of the followers. For example, the system and method as set forth in the present application may be implemented as a server-mobile App system, such as “Vid Platform,” and the users of the server-mobile App system form their own social platform and share the group videos among themselves.

According to embodiments, the videos may be organized and displayed in a calendar-type format. For example, a video created by a first user on May 22 may be represented by a thumbnail image of the created video on a calendar day corresponding to May 22. Additionally, when a video stretches over multiple days an indication, for example a line or ellipsis, is provided, which indicates what days the video spans. For example, a video created by a first user over the course of three days, for example May 19^{th} to May 21^{st}, may be represented by individual thumbnails on each of those days. A line is drawn around those days indicating that the video spans these days. According to further embodiments, an indication may be displayed that indicates that a plurality of videos have been linked, as previously discussed.

According to further aspects, created videos may also be tagged by a user. For example, if a user creates a video of themselves drinking coffee, a user may input the tag “coffee” for the video. Such a tag may then become metadata associated and stored with the created video. The tag may be searchable such that when a user inputs a search request, all videos with a tag corresponding to the search request are displayed, for example, in the calendar-type display. Thus, the resulting calendar-type display may only display days and corresponding video thumbnails of videos that meet the search criteria. The displayed videos may be organized in a calendar-type display so that a user may easily discern the dates on which the videos were created. According to embodiments, a plurality of tags may be created for each video. Additionally, tags may be automatically generated based upon video analysis of the created video. According to one embodiment, the present method and system may generate tags by performing video analysis utilizing machine learning. According to another embodiment, tags may be automatically created according to metadata of the video (e.g., geolocation metadata). According to further embodiments, a user may search for videos according to location information of the videos. For example, a user may search for “Miami beach” and all videos that were created in Miami beach will be retrieved and displayed in a calendar-type display format.

According to further aspects of the present application, the system and method may automatically create videos based upon metadata from third party services that a user engages with. For example, a user of the Vid Platform that also uses a travel service (e.g., Airbnb) may have information from their recent travels imported into the Vid Platform for automatic creation of a video.

According to another aspect, the present application is directed to a recording medium storing an executable program that causes a processor to implement the method as set forth in the present application.

### BRIEF DESCRIPTION OF THE DRAWINGS

The above and other objects, features, and advantages of various embodiments as set forth in the present disclosure will be more apparent from the following detailed description of embodiments taken in conjunction with the accompanying drawings.

FIG. 1 illustrates a video editing system according to an embodiment of the present application.

FIG. 2 illustrates an exemplary structure of an electronic device according to an embodiment of the present application.

FIG. 3a illustrates a graphical user interface of a local application for publishing a video according to an embodiment of the present application.

FIG. 3b illustrates a graphical user interface of a local application for publishing a video including a plurality of clips according to an embodiment of the present application.

FIG. 4 illustrates a graphical user interface of a local application for presenting videos according to an embodiment of the present application.

FIG. 5 illustrates a graphical user interface of a local application for presenting videos according to an embodiment of the present application.

### DETAILED DESCRIPTION

It will be appreciated by those ordinarily skilled in the art that the foregoing brief description and the following detailed description are exemplary (i.e., illustrative) and explanatory of the subject matter as set forth in the present disclosure, but are not intended to be restrictive thereof or limiting of the advantages that can be achieved by the present disclosure in various implementations.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like.

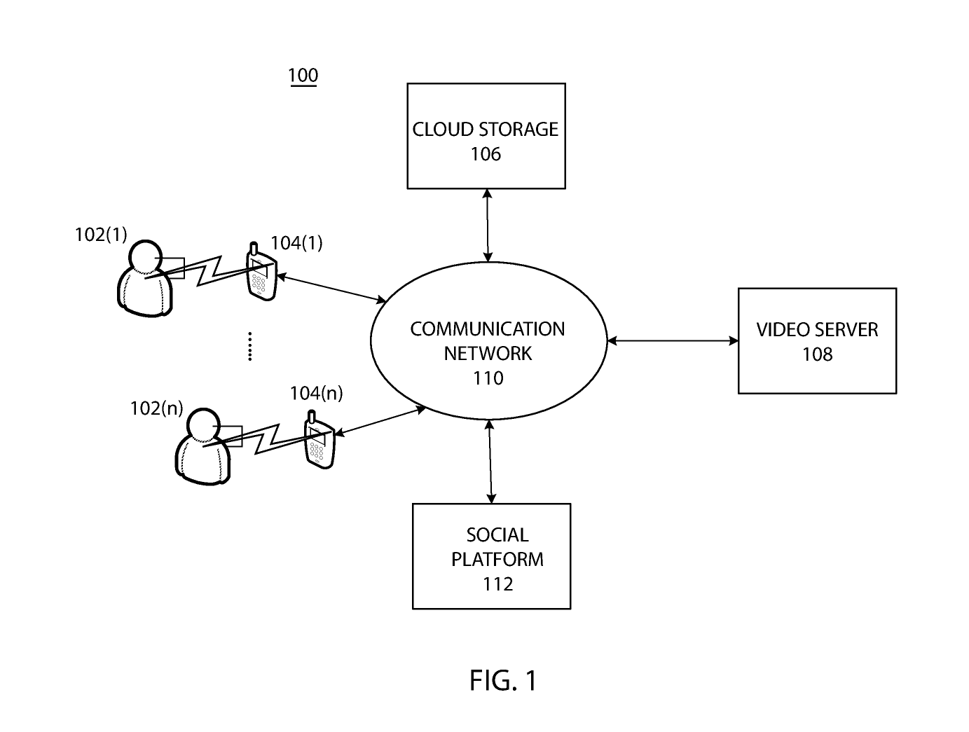

FIG. 1 illustrates a video editing and creation system 100 according to an embodiment of the present application. The video editing and creation system includes a plurality of users 102(1) to 102(n) who operate electronic devices 104(1) to 104(n) to communicate with, via a communication network 110, a cloud storage 106, a video server 108, and a social platform 112. For the sake of brevity, the plurality of users 102(1) to 102(n) and the plurality of electronic devices 104(1) to 104(n) will be collectively referred to as the user 102 and the device 104 in this application, respectively, when the distinction among these users and devices is not needed. The plurality of users 102 may be a group of users who have attended a social event together, such as a sport event, a party, and a sightseeing. The plurality of users may be a group of users who have connected with each other via social platforms. In another embodiment, the plurality of users may be a group of user who have no connections with each other, but happen to be at a similar location and similar time with each other. The present video creation system and method allow the plurality of users 102 to create a group video by using all videos that have been provided by each of the plurality of users 102. In this way, the created group video can have a richer content than any of those individual videos. The video editing and creation system further allows users to create their own videos by combining a plurality of clips together, where the video may span a plurality of days.

The electronic device 104 is used by the user to record and store a plurality of video files. In an embodiment, the user 102 may also use the electronic device 104 for recording and then send the recorded video file to the cloud storage 106 for storage. The user 102 may also select one or more videos file, including the group video, to be published on the social platform 112. When the group video is published, a single feed about the group video is published in each account of the users 102. In this way, all followers of the users 102 on the social platform have a direct access to the group video and notice the publication of the group video. For example, a link to the group video may be provided on the home page of each of the users 102 such that every one who is allowed to visit those home pages can access the video via the link. The video server 108 provides a series of processes and algorithms that assist the users 102 to create a group video, including setting up a group video project, discovering relevant participants of the group video project, logging changes to the group video made by each participant, providing real-time updates to each participant, and publishing the generated group video. The video server 108 further provides a series of processes and algorithms that assist the users 102 to create an individual video, including setting up an individual video project, combining clips into a video, adding audio to the clips and or individual video, and organizing the clips according to date, time, and location information. Detailed functions and process of the video server will be disclosed in the following parts of the present application.

As used in the present application, a server, a system, a cloud storage, or an electronic device may comprise a full-sized personal computer, a mobile device, a wearable device, or even a virtual device capable of exchanging data over a network. For example, a server, a system, or an electronic device may be an iPhone, an Android phone, a Blackberry phone, an iWatch, an iPad, or other internet-capable devices. The virtual device as used in the present application may refer to those virtual representations of a physical device, which is created by virtual reality technologies.

The communication network 110 should be broadly construed to include any one or more of a number of types of networks that may be created between devices using an internet connection, a LAN/WAN connection, a wireless connection, and so forth. For example, an electronic device may be operatively connected to network 110, via 3G 4G 5G or LTE networks. The terms “coupled with,” “operatively connected,” “operatively coupled,” and “communicatively coupled”, as used herein, mean that the elements so connected or coupled are adapted to transmit and/or receive data, or otherwise communicate. The communication network 110 may comprise various configurations and protocols including a cable network, the internet, World Wide Web, intranets, virtual private networks, wide area networks, local networks, private networks using communication protocols proprietary to one or more companies, Ethernet, WiFi and HTTP, cloud and cloud based services, and various combinations of the foregoing.

The social platform 112 may be understood as an online community for members to interact with each other. Some currently well-known social platforms include Facebook, Twitter, Google+, Four Squares, Instagram, Pinterest, and Tumblr. In an embodiment, the users of the video server 108 may form their own social platform. For example, the system and method of the present application may be implemented in a server-mobile app system. The users of the server-mobile app system may form their own social platform called “Vid Platform.” In a social platform, a follower represents a user who chooses to see some or all of another user's posts in their content feed. The number of followers of a user indicates the influence of that user in a social platform. An important objective for a user to publish a content in a social platform is to raise his or her status in the social platform, attract more followers, and increase his or her influence in the social platform. According to an embodiment of the present application, when a user 102 publishes a group video, the followers of all the participants in creating the group video will receive a content feed from the group video server such that the followers have directly access to the published group video, thus increasing the impact and influence of the created group video. According to another embodiment, the video server uses the followers in a social platform as a factor to search for potential participants for a group video. According to a further embodiment of the present application, when a user publishes an individual video, the followers of the individual video will receive a content feed from the video server such that the followers have direct access to the individual video.

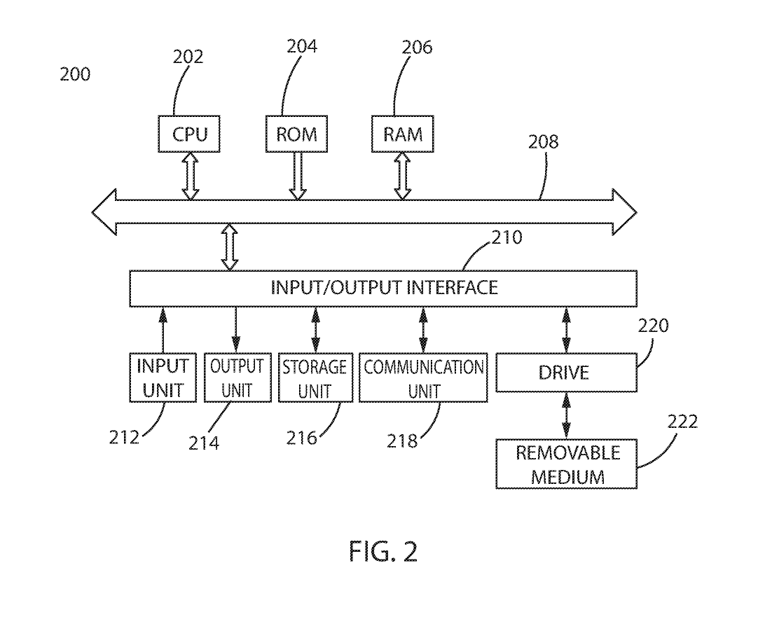

FIG. 2 illustrates an exemplary structure 200 of a server, a system, or an electronic device according to an embodiment. The exemplary structure 200 includes a CPU 202, a ROM 204, a RAM 206, a bus 208, an input/output interface 210, an input unit 212, an output unit 214, a storage unit 216, a communication unit 218, and a drive 220. The CPU 202, the ROM 204, and the RAM 206 are interconnected to one another via the bus 208, and the input/output interface 210 is also connected to the bus 208. In addition to the bus 208, the input unit 212, the output unit 214, the storage unit 216, the communication unit 218, and the drive 220 are connected to the input/output interface 210.

The CPU 202, such as a microprocessor, executes various kinds of processing in accordance with a program stored in the ROM 204 or in accordance with a program loaded into the RAM 206 from the storage unit 216 via the input/output interface 210 and the bus 208. The ROM 204 has stored therein a program to be executed by the CPU 202. The RAM 206 stores as appropriate a program to be executed by the CPU 202, and data necessary for the CPU 202 to execute various kinds of processing. The CPU 202 may include multiple processors such as ASICs, FPGAs, GPUs, etc. A program may include any set of instructions to be executed directly (such as machine code) or indirectly (such as scripts) by the processor. In that regard, the terms “instructions,” “steps” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

The input unit 212 includes a keyboard, a mouse, a microphone, a touch screen, and the like. When the input unit 212 is operated by a user, the input unit 212 supplies an input signal based on the operation to the CPU 202 via the input/output interface 210 and the bus 208. The output unit 214 includes a display, such as an LCD, or a touch screen or a speaker, and the like. The storage unit 216 includes a hard disk, a flash memory, and the like, and stores a program executed by the CPU 202, data transmitted to the terminal 200 via a network, and the like.

The communication unit 218 includes a modem, a terminal adaptor, and other communication interfaces, and performs a communication process via the networks of FIG. 1.

A removable medium 222 formed of a magnetic disk, an optical disc, a magneto-optical disc, flash or EEPROM, SDSC (standard-capacity) card (SD card), or a semiconductor memory is loaded as appropriate into the drive 220. The drive 220 reads data recorded on the removable medium 222 or records predetermined data on the removable medium 222.

An operating system such as Microsoft Windows 10®, Microsoft Windows 7®, Windows XP® or Vista™, Linux °, Mac OS®, Unix °, iOS®, or Android °, may be used by the terminal. Other programs may be stored instead of or in addition to the operating system. It will be appreciated that a computer system may also be implemented on platforms and operating systems other than those mentioned. Any operating system or other program, or any part of either, may be written using one or more programming languages such as, e.g., Java®, C, C++, C#, Visual Basic®, VB.NET®, Perl, Ruby, Python, SWIFT, OBJECTIVE C, or other programming languages, possibly using object oriented design and/or coding techniques.

Data may be retrieved, stored or modified in accordance with the instructions. For instance, although the system and method is not limited by any particular data structure, the data may be stored in computer registers, in a relational database as a table having a plurality of different fields and records, XML documents, flat files, JSON files, etc. The data may also be formatted in any computer-readable format such as, but not limited to, binary values, ASCII or Unicode. The textual data might also be compressed, encrypted, or both. By further way of example only, image data may be stored as bitmaps comprised of pixels that are stored in compressed or uncompressed, or lossless or lossy formats (e.g., JPEG), vector-based formats (e.g., SVG) or computer instructions for drawing graphics. Video data may be encoded in a plurality of encoding formats, such as H.246 and MPEG and stored as AVI, MP4, MOV, or M4V files. Audio data may also be encoded in a plurality of encoding formats, such as AAC, AMR, and MPE, and stores as MPE or WAV files. Moreover, the data may comprise any information sufficient to identify the relevant information, such as numbers, descriptive text, proprietary codes, pointers, references to data stored in other memories (including other network locations) or information that is used by a function to calculate the relevant data.

It will be understood by those of ordinary skill in the art that the processor and memory may actually comprise multiple processors and memories that may or may not be stored within the same physical housing. For example, some of the instructions and data may be stored on removable memory such as a magneto-optical disk or SD card and others within a read-only computer chip. Some or all of the instructions and data may be stored in a location physically remote from, yet still accessible by, the processor. Similarly, the processor may actually comprise a collection of processors which may or may not operate in parallel. As will be recognized by those skilled in the relevant art, the terms “system,” “terminal,” and “server” are used herein to describe a computer's function in a particular context. A terminal may, for example, be a computer that one or more users work with directly, e.g., through a keyboard and monitor directly coupled to the computer system. Terminals may also include a smart phone device, a personal digital assistant (PDA), thin client, or any electronic device that is able to connect to the network and has some software and computing capabilities such that it can interact with the system. A computer system or terminal that requests a service through a network is often referred to as a client, and a computer system or terminal that provides a service is often referred to as a server. A server may provide contents, content sharing, social networking, storage, search, or data mining services to another computer system or terminal. However, any particular computing device may be indistinguishable in its hardware, configuration, operating system, and/or other software from a client, server, or both. The terms “client” and “server” may describe programs and running processes instead of or in addition to their application to computer systems described above. Generally, a (software) client may consume information and/or computational services provided by a (software) server.

The Vid Platform allows a user to create and store the user's personal information, account information in a social platform, and privacy settings associated with the use of the video server. The personal information may include the user's actual name, address, and contact information. The account information in a social platform may include names used by the user in various social platforms, and the list of followers associated with each account. The privacy settings may include the user's preferences and restrictions.

The Vid Platform also manages video projects, including selecting audio data for created videos.

Another function of the Vid Platform is to provide a plurality of video editing options to participants, such as changing display order, trimming the video length, or adjusting the video resolution. In one embodiment, the video server merely provides these options to the participants, but does not provide the actual video editing functions associated with these options. Instead, the local electronic device has those video editing functions and implements the actual video editing tasks. In this way, the processing requirement and the network traffic imposed on the group video server are greatly reduced, thus allowing the group video server to handle many group video editing requests in real-time.

In one embodiment, a tune selection module of the Vid Platform includes those functions and algorithms as described in U.S. application Ser. No. 15/686,842, titled “System and Method for Combining Audio Tracks with Video Files,” filed on Aug. 25, 2017, the entirety of which is incorporated herein by reference.

In an embodiment, the video server extracts location information from a video file of a storyboard and names the storyboard by a landmark or address associated with the location information. The local application transmits, to the video server, information about the storyboard, including identification of the user, the name of the storyboard, metadata of the added video, and time and date associated with the event that is the subject of the video. In one embodiment, the local application further transmits a reduced version of the video file added by the user. The reduced version may be thumbnail images extracted from the video file or may be the same video file but with reduced resolution or frame rate. The thumbnail image may be a grayscale image of the beginning frame of the video file. In an alternative embodiment, the local application transmits a copy of the entire video file to the group server 300 after the reduced version of thumbnail image has been transmitted.

Upon, receiving the above-identified information, the video server establishes a direct and persistent communication with the user's electronic device, such as by maintaining a WebSocket connection with the electronic device of the user. The video server also extracts the location and time data from the metadata

The video server may first arrange the video files according to their time information. In another example, the video server may first separate the added video files according to their location information by placing video files adjacent to one location into a same group and them arrange the video file according to the time they were recorded in each group. The user is allowed to add audio data, such as a tune, to the video, as described the previous parts of the present application. The video server publishes the video by posting a video feed or link. In another embodiment, the video server may also publish the video feed or link to all followers of the user.

In another embodiment, the present system and method will request a consent from a user to share his/her location even when a local application associated with the present system and method is not running. This will allow the local application to send a signal to the video server at specific intervals with the time and location information of a user.

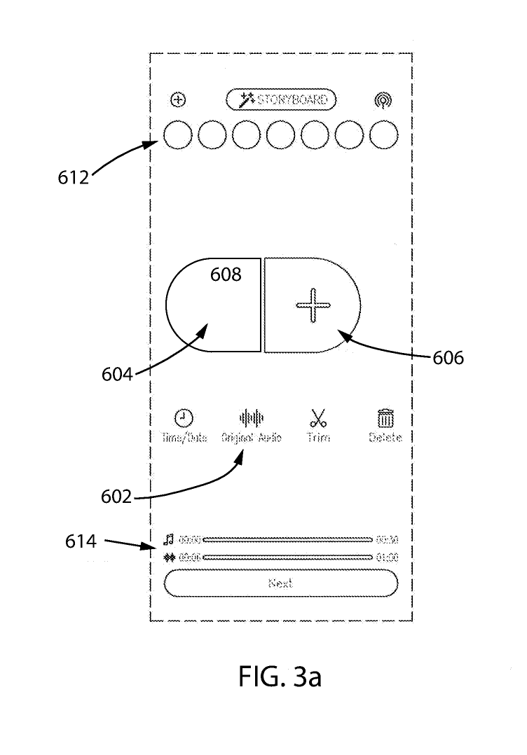

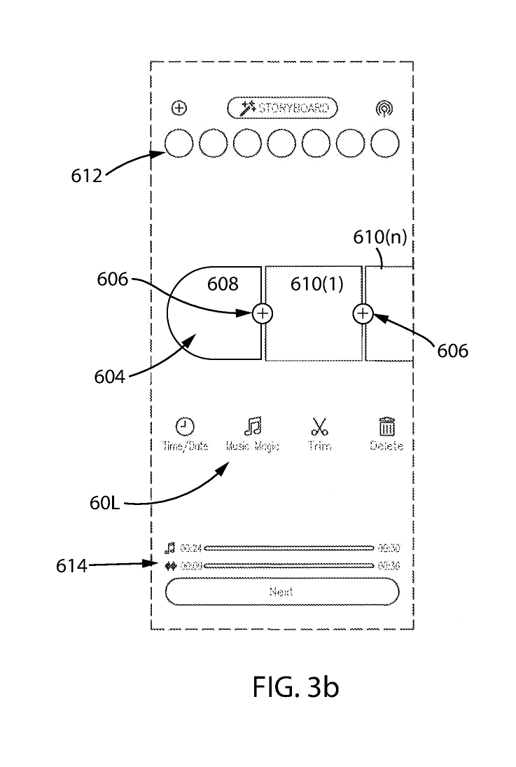

FIGS. 3a-b illustrate graphical user interfaces of a mobile application installed on an electronic device 102 according to embodiments of the present application. The electronic device may be an Android phone or an iOS phone. The mobile application, known as an “App,” is installed on the electronic device to assist a user to create a video.

Methods for creating an individual video project using a local application installed on the electronic device 102 will now be described. The individual video project may be referred to as a storyboard in the present application. The user gives a name to the storyboard and uploads a video file to the storyboard. In an embodiment, the video server extracts location information from a video file of the storyboard and names the storyboard by a landmark or address associated with the location information. The local application transmits, to the video server, information about the storyboard, including identification of the user, the name of the storyboard, metadata of the added video, and time and date associated with the event that is the subject of the video. In one embodiment, the local application further transmits a reduced version of the video file added by the user. The reduced version may be thumbnail images extracted from the video file or may be the same video file but with reduced resolution or frame rate. The thumbnail image may be a grayscale image of the beginning frame of the video file. In an alternative embodiment, the local application transmits a copy of the entire video file to the server after the reduced version of thumbnail image has been transmitted. Upon, receiving the above-identified information, the group server 300 establishes a direct and persistent communication with the user's electronic device, such as by maintaining a WebSocket connection with the electronic device of the user.

FIG. 3a illustrates a graphical user interface for a user to add video clips to a storyboard, which represents embodiments of the individual video creation project. The user interface provides a function 602 for adding a tune to individual video projects, a function 604 for selecting a first video from a local storage or cloud storage, or server storage, and a function 606 for selecting at least one second video from a local storage or cloud storage, or server storage.

According to embodiments, a user that wishes to create an individual video project adds a first video clip 608 by selecting function 604. Function 604 may be understood to be a virtual button or icon, which when selected, causes a processor of the electronic device to carry out specific function(s) according to program code embedded in the device. By selecting function 604, the user is prompted to add the first video clip. The first video clip may be a video locally recorded by the user's electronic device or it may be a video stored remotely. The user then has the option to add at least one second video clip 610 by selecting function 606. Similar to function 604, function 606 may also be understood to be a virtual button or icon, which when selected, causes a processor of the users electronic device to carry out specific function(s). By selecting function 606, the user is prompted to add at least one second video clip. The at least one second video clip may be a video locally recorded by the user's electronic device or it may be a video stored remotely.

FIG. 3b illustrates the graphical user interface of FIG. 3a when multiple video clips are added to an individual video project. As discussed above, when a user selects function 606 for the first time, the user is prompted to add a second video clip 610 to the individual video project. Once added, a thumbnail of the second video clip 610(1) is displayed alongside a thumbnail of the first video clip 608. The user may add a plurality of second video clips 610(n) so as to create an individual video project comprising a plurality of video clips. As the user adds video clips, function 606 is placed in between added video clips so that a user may selectively add new video clips in between already selected video clips. According to embodiments, a user may also move already selected video clips so as to rearrange the order of the video clips. Once a user has selected all video clips, the video clips may be compiled into a single individual video. The compiling may comprise stitching the individual video clips in a serial manner according to the order that they have been organized by the user. Calendar indicator 612 provides a visual indication of the dates of each of the video clips that have been added to the individual video project. For example, according to embodiments, each of the icons (e.g., circles) may represent an individual calendar day, each icon corresponding to a date on which one of the video clips was created. In this way, the user is provided with an understanding of the dates on which the video clips that comprise the individual video project were created. According to embodiments, calendar indicator 612 may be created according to metadata of each of the individual video clips. For example, video clips recorded within the App on the electronic device 102 are time and/or date stamped as they are recorded. This stamp, which may be considered metadata, is used to generate indicator 612.

Timebars 614 may also be displayed during creation of the individual video project. The timebars 614 may indicate how long the resulting compiled video will be as well as the length of audio the compiled video will include. It will be appreciated that the resulting compiled video of the individual video project may include any number of video clips (i.e., 1, 2, 10 etc.).

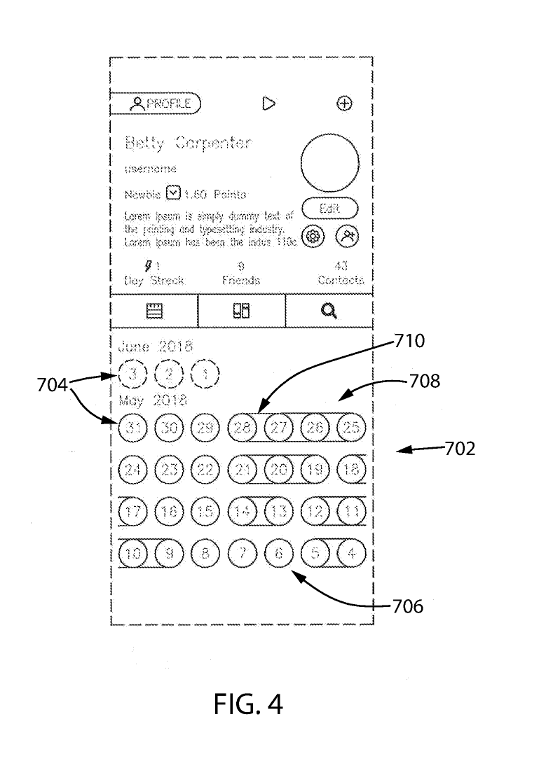

FIG. 4 illustrates a user interface with video files created by the user. This interface may be understood as the user's profile page. Display area 702 may include a calendar-type display. According to embodiments, display area 702 includes a plurality of icons 704 (e.g., circles) that each represent an individual calendar day. Each icon 704 may display a numeral that corresponds to a calendar day. Thumbnails of videos created by the user (e.g., group videos or individual videos) may be displayed within display area 702. For example, according to an embodiment, a thumbnail of each video (or video clip) is displayed within an icon 704 of display area 702. According to a preferred embodiment, each thumbnail is displayed in an icon 704 that corresponds to the calendar day that an associated video was created. The thumbnail image may be extracted from the video file or may be the same video file but with reduced resolution or frame rate. The thumbnail image may be a grayscale image of the beginning frame of the video file. The thumbnail may alternative be selected by the user.

Display area 702 may also be configured to dynamically provide an indication of the number of calendar days that an individual video spans. According to embodiments, a composite video including a single (or multiple) video clip(s) from a single day will be presented as a single thumbnail corresponding to that day. For example, a video that was created on May 6, 2018 may be represented by a single thumbnail 706 within an icon 704 that correspond to May 6, 2018. According to these embodiments, a video that includes a single (or multiple video clips) from more than one day will be presented as a plurality of thumbnails with an associated indicator 710. For example, when a video 708 includes video clips spanning from May 25^{th} to May 28, 2018, thumbnails of the video are presented in icons 704 that correspond to each of these days. Display area 702 may also present an indicator 710, which encircles or otherwise indicates that these video clips are a part of a single video. In this way, display area 702 advantageously provides dynamic indications of the date or range of dates on which videos are created. Thus, display area 702 may be dynamically updated and changed according to the videos created by a user.

According to embodiments, video thumbnails are presented on the calendar-type display 704 described above according to metadata associated with each video. The created videos may each have metadata associated therewith, the metadata including date and time information. According to embodiments, the date and time information corresponds to the date and/or time the video was created, the length of the video, the date and time the video finished recording, and/or the number of days, and the associated dates, that the video spans. The user's electronic device (or the server) may analyze this metadata and present thumbnails of the video according to the date and/or time of the metadata. The metadata is thus utilized in order to both organize the videos in the calendar-type display area 702 as well as create and present indicators 710.

According to certain embodiments, video clips are automatically put into sequential order according to the metadata associated with each video clip. For example, according to one embodiment, a user's electronic device includes software instructions, which when executed put video clips recorded through the Vid App into a chronological order and display their thumbnails in such an order. The display may be that as depicted in FIG. 3B (e.g., 608, 610(1), 610 (n), etc.).

Various examples of the above embodiments will now be described, for illustration purposes only. According to a first example, a user opens the Vid App and records a plurality of video clips on May 15. Each video clip is recorded with associated metadata, for example, in the form of a time stamp. These video clips are automatically put into chronological order and displayed, for example, in a format as depicted in FIG. 3B. The user may then choose to rearrange the video clips, remove certain video clips, or add additional video clips. The user then publishes the composite video, which includes the plurality of video clips, to their profile and/or new feed. When viewing their profile, the composite video will be represented by a single thumbnail displayed within an icon that represents May 15 on the calendar-like display (see, e.g., FIG. 4). According to an alternative example, a user opens the Vid App and records a plurality of video clips on May 15. Each video clip is recorded with associated metadata, for example, in the form of a time stamp. These video clips are automatically stored and organized in chronological order. When the user wants to make a composite video, the user selects icon 604, which then presents a pop-up window (or any other type of display), which provides thumbnails of the recorded video clips, for example, in chronological order. The user then selects a first video clip 608 from the pop-up window. The user can then add video clips via icon(s) 606 as desired.

According to a second example, a user opens the Vid App and records a plurality of video clips over the course of several days, for example, May 19^{th} to May 21^{st}. Each video clip is recorded with associated metadata, for example, in the form of a time stamp. These video clips are automatically put into chronological order and displayed, for example, in a format as depicted in FIG. 3B. The user may then choose to rearrange the video clips, remove certain video clips, or add additional video clips. According to an alternative example, a user opens the Vid App and records a plurality of video clips from May 19^{th} to May 21^{st}. Each video clip is recorded with associated metadata, for example, in the form of a time stamp. These video clips are automatically stored and organized in chronological order. When the user wants to make a composite video, the user selects icon 604, which then presents a pop-up window (or any other type of display), which provides thumbnails of the recorded video clips, for example, in chronological order. The user then selects a first video clip 608 from the pop-up window. The user can then add videos via icon(s) 606 as desired. The user then publishes the composite video, which includes the plurality of video clips, to their profile and/or new feed. When viewing their profile, the composite video will be represented by a plurality of thumbnails displayed within icons that represents May 19 to May 21 on the calendar-like display along with indicator 710 (e.g., an oval-like shape) surrounding the icons (see, e.g., FIG. 4).

According to a third example, a user opens the Vid App and records a plurality of video clips over the course of several non-consecutive days, for example, May 25^{t}h May 26^{th}, and May 31^{st}. Each video clip is recorded with associated metadata, for example, in the form of a time stamp. These video clips are automatically put into chronological order and displayed, for example, in a format as depicted in FIG. 3B. The user may then choose to rearrange the video clips, remove certain video clips, or add additional video clips. According to an alternative, a user opens the Vid App and records a plurality of video clips. Each video clip is recorded with associated metadata, for example, in the form of a time stamp. These video clips are automatically stored and organized in chronological order. When the user wants to make a composite video, the user selects icon 604, which then presents a pop-up window (or any other type of display), which provides thumbnails of the recorded video clips, for example, in chronological order. The user then selects a first video clip 608 from the pop-up window. The user can then add videos via icon(s) 606 as desired. According to this example, a user has chosen not to publish the video clips from May 25^{th} and May 26^{th} alone, or the user has forgotten to do so. The user then publishes the video clips, which includes the plurality of video clips, to their profile and/or new feed. When viewing their profile, the video clips will be represented by a plurality of thumbnails displayed within icons that represents May 25^{th}, May 26^{th}, and May 31^{st} on the calendar-like display along with an indicator 710 (e.g., an oval-like shape) surrounding the icons as well as intervening blank icons (e.g., icons for May 27^{th} through May 30^{th}).

According to a variation of example three, a user opens the Vid App and records a plurality of video clips over the course of several non-consecutive days, for example, May 25^{th}, May 26^{th}, and May 31^{st}. Each video clip is recorded with associated metadata, for example, in the form of a time stamp. The user may decide that the video clips of May 25^{th} and May 26^{th} should be a part of a single composite video. These video clips are automatically put into chronological order and displayed, for example, in a format as depicted in FIG. 3B. The user may then choose to rearrange the video clips, remove certain video clips, or add additional video clips. According to this example, a user has chosen not to publish the composite video from May 25^{th} and May 26^{th} alone, or the user has similarly forgotten to do so. Subsequently the user records at least one video clip on May 31^{st} and creates a composite video for that day. The user then publishes the composite videos (e.g., the video from May 25^{th} and 26^{th}, and the video from May 31^{st}), which includes the plurality of video clips, to their profile and/or new feed. When viewing their profile, the video clips will be represented by a plurality of thumbnails displayed within icons that represents May 25^{th}, May 26^{th}, and May 31^{st} on the calendar-like display along with an indicator 710 (e.g., an oval-like shape) surrounding the icons as well as intervening blank icons (e.g., icons for May 27^{th} through May 30^{th}). Because the composite video from May 25^{th} and 26^{th} was not previously published it is automatically linked to the video from May 31^{st}.

What can be recognized by the above examples, and according to certain embodiments, video clips may be automatically linked to each other, based on a time stamp representing when they were created, in a chronological fashion over any span of time, and uniquely presented in a calendar-like display with associated indicators. Once a video (or plurality of videos) is published the link (e.g., indicator 710) is completed, and a new link may be created between new videos/video clips. In this way, the present disclosure describes methods of linking videos dynamically based upon metadata and publishing information.

According to aspects of the present disclosure, video clips may be automatically generated utilizing information from third party services. The information may include, but is not limited to, date/time, location, and subject matter information. According to an illustrative embodiment, the Vid Platform is configured to automatically acquire data from these services and automatically generate a video that may be added to the calendar-type display of the present application.

According to embodiments, the Vid Platform is configured to automatically acquire metadata from a plurality of third party services. The Vid Platform may scrape or otherwise access the metadata from each of the third party services once the user has permitted the Vid Platform to access such information. For example, according to one embodiment, once the user has permitted access, a server (e.g., server 108) sends a request to the third party service, requesting metadata associated with the user's use of their service. According to one alternative embodiment, the Vid Platform acquires the metadata directly from the user's electronic device. The metadata may then be sent to a server (e.g., server 108). The server is configured to generate video clips according to the metadata for presentation and local storage at the user's device 104. According to an alternative embodiment, the video clips are locally generated on the user's electronic device. These generated video clips may then be utilized to create individual or group video projects as well as for presentation on the calendar-type display (as described above).

According to the above embodiments, the Vid Platform is configured to standardize the metadata retrieved from the third party services according to the type of service. For example, the third party services may include, but are not limited to, shopping services (e.g., Amazon, Walmart, etc.), entertainment services (e.g., Netflix, Ticketmaster, HBO GO, Hulu, etc.), fitness services (e.g., Fitbit, Nike band, Apple Health, etc.), gaming services (e.g., Xbox Live, PlayStation network, etc.), travel and transportation services (e.g., Airbnb, Expedia, Uber, Lyft, American Airlines, etc.), and vehicle services (e.g., on-board services for automobiles). Metadata for each type of service is standardized in order to automatically create video clips that accurately present relevant information for that category. For example, for shopping services the retrieved metadata may include item name, item price, a picture of the item, a time/date that the purchase occurred, and the location where the purchase occurred. For entertainment services, the retrieved metadata may include a media title, a picture illustrating the media item, a time/date that the media was viewed, the location where the media was viewed, and the name of the service that provided the media. For travel services, the retrieved metadata may include departure and arrival locations, a picture representing the arrival location, and date/time information for a user's travel plan. For fitness services, the retrieved metadata may include, an exercise type, a date/time/length of the exercise routine, step count, calories burned, the type of service used to record the exercise, and the location of the user during the exercise. The metadata is then used to create a video clip, which presents the metadata in a visual form. The above service types and retrieved metadata are merely for illustrative purposes, and additional types of services, as well as the type of retrieved metadata, is within the scope of the present disclosure. Videos automatically generated in this way from metadata may be known as “Autogen Memories.”

According to an illustrative example, a user of the Vid Platform may use a travel service for booking reservations (e.g., Airbnb®). In one embodiment, a user of the Vid Platform accesses setting features of the Vid App, and selects the third party application (here Airbnb) from which metadata access is desired. According to an alternative embodiment, a user provides their credentials to the third party application, for example, a user name and password on the Airbnb® mobile application, the Vid Platform is given access to data that the Airbnb® mobile application generates. For example, the Vid Platform will automatically acquire reservation information, such as the date and location of a reservation, and generate a video that indicates that the user was at the location at that date using Airbnb®. The video may also contain and present a map of the destination location and an animation illustrating travel from the starting location to the destination.

According to another example, the Vid Platform may automatically generate a video clip based on a media item that the user viewed. For example, a video clip may be automatically generated to include a title of a movie (or TV show) that the user viewed. This video clip may also include the location of the user while watching the movie, as well when the movie was watched and the service that the movie was viewed through (e.g., Netflix). Furthermore, the video clip may display the time and date that a user accessed a particular media item (e.g., a TV show, a movie, a song, a digital book, etc.), as well as information describing the media item (e.g., title, author, genre, actors names, etc.).

The automatically generated videos, as described above, may also automatically be added and tagged to the user's profile of the Vid Platform. These videos may also be added to the calendar-type display. In this way, the Vid Platform automatically catalogues user's events and presents them in a chronological order (e.g., in a calendar-type display).

According to embodiments, a user may specify privacy setting for each video/clip. For example, a user may prevent a video from being published in the accounts of participants on a social media platform such that followers do not have access to private videos. In such instances, an additional icon (not shown), e.g., an icon of a padlock, may be presented within icon 704 that correspond to videos that are made private.

For example, according to an illustrative embodiment, a user creates a plurality of videos. The user has indicated that some of these videos are private, while other are public. When the user views their profile page, the calendar-type display will show all of the videos as thumbnails located within their respective calendar location (i.e., calendar date), as described above. However, when a third party user views the user's profile page only those videos that have been indicated as public are seen in the calendar-type display. The videos marked as private are not shown, and instead the calendar-type display would only display empty spaces at calendar locations (i.e., dates) corresponding to the private videos.

According to embodiments, videos created by users of the Vid App are secured via an encryption algorithm. In other words, videos (or other data) created in the Vid app are encoded in such a way that they can only be accessed by authorized persons (e.g., with a secret key or password or via user permission). According to one embodiment, the videos (and other data) are secured within the Vid app (and associated cloud/network) via zero-knowledge encryption. According to this embodiment, the communication network, cloud storage, and social platform of the present invention does not store or know a user's private password (e.g., symmetric key). In this way, if the Vid platform is compromised the user's private password remains safe. Additionally, this provides an encryption technique that ensures that the social platform does not have access to users' files and encryption keys in a readable format.

According to further embodiments, a plurality of created videos may be linked by other means. For example, a plurality of videos may be linked according to user input. According to still further embodiments, a plurality of videos may be linked according to the subject matter of the videos. For example, the metadata associated with each created video may further include location information. The location information may correspond to a location where the created video was made.

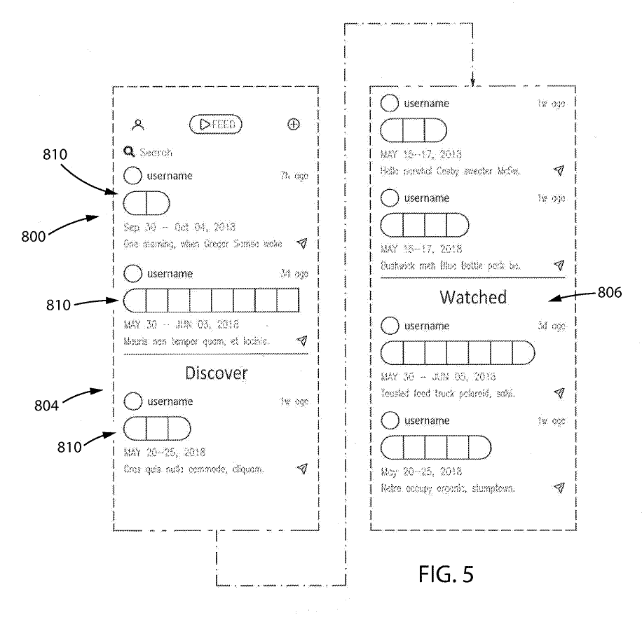

FIG. 5 illustrates a user interface with a user's news feed of other users that are follows. A user's newsfeed may comprise, according to embodiments, other users videos. For example, the newsfeed may be broken into three sections. Section 802 may be a feed section that presents new videos from other user's that the user currently follows. Section 804 may be a feed section that presents videos from users that the user currently does not follow. Section 806 may be a feed section that presents other user's videos previously viewed by the user. Within each section thumbnails of other user's videos are presented in a “capsule-like” fashion. For example, according to embodiments, when another user posts a composite video that comprising a plurality of video clips, the news feed presents an icon 810 that includes thumbnails of each video clip comprised in the composite video. The size (e.g., length) of icon 810 depends upon the number of video clips that the composite video includes. Thus, as FIG. 5 illustrates, icon 810 varies in size.

Further embodiments of the present disclosure include tagging videos created by users. For example, if a user creates a video of themselves drinking coffee, a user may input the tag “coffee” for the video. Such a tag may then be meta-data associated and stored with the created video. The tag may be searchable such that when a user inputs a search request, all videos with a tag corresponding to the search request are displayed. Thus, the resulting calendar-type display may only display days and corresponding video thumbnails of videos that meet the search criteria. The displayed videos may be organized in a calendar-type display so that a user may easily discern the dates on which the videos were created. According to embodiments, a plurality of tags may be created for each video. Additionally, tags may be automatically generated based upon video analysis of the created video. According to further embodiments, a user may search for videos according to location information of the videos. For example, a user may search for “Miami beach” and all videos that were created in Miami beach will be retrieved and displayed in a calendar-type display format.

The plurality of video creating, editing, displaying, and organizing functions, such as changing a display order, trimming video length, or adjusting the video resolution may be carried out by group video server 300. In one embodiment, the video server merely provides these options to the participants, but does not provide the actual functions associated with these options. Instead, the local electronic device 102 has those functions and implements the actual tasks. In this way, the processing requirement and the network traffic imposed on the group video server are greatly reduced, thus allowing the group video server to handle many requests in real-time.

While aspects of the present disclosure have been described in conjunction with the specific embodiments outlined above, it is evident that many alternatives, modifications, and variations will be apparent to those ordinarily skilled in the art. Accordingly, the preferred embodiments of the invention as set forth above are intended to be illustrative, not limiting. Various changes may be made without departing from the spirit and scope of the inventions as defined in the following claims.

What is claimed is:

1. A system for social networking, comprising:
a server;
an electronic device having a user interface, the electronic device communicating with the server over a communication network; and
a program product comprising machine-readable code for causing, when executed, the electronic device to perform the following steps:
prompt a user, on the user interface, to create a plurality of videos, the plurality of videos each comprising a time stamp, wherein the time stamp represents a time and date that a respective video was created;
transmit the plurality of videos to the server; and
display, on the user interface, a calendar-like display, the calendar-like display displaying a plurality of days in chronological order and a plurality of first icons representing the plurality of videos, wherein the plurality of first icons are located on a respective day of the plurality of days according to their time stamp;
wherein the calendar-like display is shared with at least one second user over the communication network.

2. The system for social networking of claim 1,
wherein the program product further comprising machine-readable code for causing, when executed, the electronic device to prompt the user to select whether each of the plurality of videos are public or private; and
wherein the calendar-like display that is shared with the at least one second user is modified to omit the icons representing videos that are private.

3. The system for social networking of claim 1,
wherein at least one of the plurality of videos comprises a plurality of video clips, each of the video clips comprising a time stamp, wherein the time stamp represents a time and date that a respective video clip was created,
wherein the program product further comprising machine-readable code for causing, when executed, the electronic device to perform the following steps:
display a plurality of second icons representing each video clip, the plurality of second icons being displayed in a chronological order according to their respective time stamps; and
allow the user to rearrange the plurality of video clips,
wherein the at least one of the plurality of videos is created by serially combining the plurality of video clips according to their order.

4. The system for social networking of claim 3,
wherein the program product further comprising machine-readable code for causing, when executed, the electronic device to perform the following steps:
link the plurality of video clips, and
display an indicator, when the plurality of video clips spans more than one day, on the calendar-like display, the indicator encircling or encapsulating the days corresponding to the plurality of video clips.

5. The system for social networking of claim 1,
wherein the program product further comprising machine-readable code for causing, when executed, the electronic device to perform the following steps:
retrieve metadata from at least one third party service; and
automatically create at least one video based at least in part on the metadata.

6. The system for social networking of claim 1,
wherein the plurality of videos are stored in a cloud storage device of the server.

7. The system for social networking of claim 6,
wherein the plurality of videos are encrypted prior to storage in the cloud storage device.

8. The system for social networking of claim 7,
wherein the encryption comprises a zero knowledge encryption.

9. A method for sharing media over a social network, comprising:
connecting a first electronic device of a first user with a server that provides communication among a plurality of users;
allowing the first user to create a plurality of videos, the plurality of videos each comprising a time stamp, wherein the time stamp represents a time and date that a respective video was created;
transmitting the plurality of videos to the server; and
displaying, on a user interface of the first electronic device, a calendar-like display, the calendar-like display displaying a plurality of days in chronological order and a plurality of first icons representing the plurality of videos, wherein the plurality of first icons are located on a respective day of the plurality of days according to their time stamp; and
sharing the calendar-like display with at least one of the plurality of users.

10. The method for sharing media over a social network of claim 9, further comprising:
prompting the first user to select whether each of the plurality of videos are public or private; and
wherein the calendar-like display that is shared with the at least one of the plurality of users is modified to omit the icons representing videos that are private.

11. The method for sharing media over a social network of claim 9,
wherein at least one of the plurality of videos comprises a plurality of video clips, each of the video clips comprising a time stamp, wherein the time stamp represents a time and date that a respective video clip was created,
wherein the method further comprises:
displaying a plurality of second icons representing each video clip, the plurality of second icons being displayed in a chronological order according to their respective time stamps; and
allowing the user to rearrange the plurality of video clips,
serially combining the plurality of video clips according to their order to create the at least one video.

12. The method for sharing media over a social network of claim 11, further comprising:
linking the plurality of video clips; and
displaying, when the plurality of video clips spans more than one day, an indicator on the calendar-like display, the indicator encircling or encapsulating the days corresponding to the plurality of video clips.

13. The method for sharing media over a social network of claim 9, further comprising:
retrieving metadata from at least one third party service; and
automatically creating at least one video based at least in part on the metadata.

14. The method for sharing media over a social network of claim 9, further comprising:
storing the plurality of videos in a cloud storage device of the server.

15. The method for sharing media over a social network of claim 14, further comprising:
encrypting the plurality of videos prior to storage in the cloud storage device.

16. The method for sharing media over a social network of claim 15,
wherein the encryption comprises a zero knowledge encryption.
